(19) United States
(12) Patent Application Publication
(10) Pub. No.: US 2015/0159394 A1
(43) Pub. Date: Jun. 11, 2015

(54) Umbrella Bucket

(71) Applicant: Joseph D. Oliveira, Poquoson, VA (US)

(72) Inventor: Joseph D. Oliveira, Poquoson, VA (US)

(21) Appl. No.: 14/102,060

(22) Filed: Dec. 10, 2013

(51) Int. Cl. E04H 12/22; A01K 97/10; F16M 11/24

(52) U.S. Cl. CPC E04H 12/22; F16M 11/24; A01K 97/10; A45B 2025/003

(57) ABSTRACT

A device for carrying items to a desired location, and there assembled into a weighted umbrella stand that also serves as a fishing rod holder. The device has a container, lid, and tube, with tube extensions providing arms extending outward from the vertical axis of the device such that fishing rod holders and fishing rods may be disposed within the arms. An umbrellas disposed within the extensions and tube, and the container is weighted with available materials such as sand, water, rocks, or the like.

### FIELD OF THE INVENTION

The invention described herein relates to beach and sport umbrella stands. More particularly, the invention disclosed is a new design for a beach and sport umbrella stand that also serves as a carryall or tote form used to carrying items to and from locations where an umbrella is desired to be used.

### BACKGROUND OF THE INVENTION

When going to the beach or spending time outside, it is often desirable to have an umbrella to provide sun and weather protection. Some of the most readily available umbrellas for these kinds of applications are beach umbrellas. Beach umbrellas, as a type, tend to be larger umbrellas than ordinary umbrellas that are utilized for daily use, but are generally small enough to be portable. Beach umbrellas are generally designed to have a single central shaft, usually with a blunt or pointed end designed to be inserted into sand or ground to keep the umbrella upright. On hard man-made surfaces, there is no readily-available means to secure the umbrella for use. And even in places with sand or soil that the end of an umbrella can be inserted into, the umbrella often gets moved or is not secured because of the nature of the ground or soil or because of windy conditions and the like.

Further, when moving or traveling with a beach umbrella; the user often is carrying other items. When going to the water front, whether a beach, river bank, or otherwise, individuals will carry towels, sunscreen, snacks, chairs, and other miscellaneous items and personal belongings. But taking such items often requires additional carrying containers and/or bags. This is especially problematic for fishermen. When going fishing, individuals need to carry additional gear including fishing rods. Often the location where the fisherman is going has no readily available means to secure fishing rods after casting and while waiting for bites on their tackle.

What is needed is a device that provides for a secure means to use a beach umbrella while also providing a means to carry items to the location where the beach umbrella is desired to be used. It is also desirable to have a device that provides a stable beach umbrella stand as well as providing means for securing fishing rods during fishing.

### SUMMARY OF THE INVENTION

The present invention is related to recreational devices, and in particular to devices that are utilized with beach and other umbrellas that are designed to be utilized in outdoor locations. The invention provides a device for providing a stable base for beach and other outdoor umbrellas as well as a carrying device so that users can carry items with them prior to using the device to secure an umbrella. The device also utilizes a modified post system to provide stabilizing holders for fishing rods. Thus, the device is a multi-purpose outdoor recreation system with multiple purposes contained in a single device.

The base of the device is a container that has a removable lid and a handle for carrying. The container portion is generally bucket-shaped, and may be modified from existing buckets for ease of construction and/or molding. The inside base of the container may, in a preferred embodiment, have a retainer portion to fit the bottom end of a hollow tubular portion (the tube) where the tubular portion inserts into the retainer in the base of the container. The removable lid has a center opening that matches the outside diameter of the tube. The device may also have extension portions (extensions) that connect to the top of the tube, the extensions being y-shaped with tubular arms that, when the extensions are connected to the tube, the arms point away from the central vertical portion of the device and may be utilized to connect fishing rod holders. The arms may extend at any desirable angle relative to the tube and umbrella pole, but generally an angle of 45 degrees or more is desirable to provide stability to the fishing rods held in the arms. There may be one or more extensions, depending upon the desires of the end user. The tubular portion and connectors are constructed to fit snugly so that they may be disassembled and reassembled repeatedly with no need to utilize glue or other permanent affixing means. It is generally desirable to not have the tube and extensions permanently affixed. With the tube and extension portions disassembled, the tube and extensions may be carried inside the container for ease of transport until the user has reached the location where they desire to set up and use the device.

Once a user has carried their desired items to the desired location, the items are removed from the container and the device is assembled for use. The tube is inserted into the retainer located in the bottom of the container. The container may then be filled with whatever is available to weight the device down and provide stability once the umbrella and fishing rods are in place. The area inside the container and surrounding the tube are filled with the desired weighing material. This may be sand, soil, rocks or other solid items, water, or whatever other materials are readily available. By utilizing materials that are readily available at the use location, the user is relieved of having to carry heavy weighting materials with them to the location.

Once the container has been weighted, the lid is placed over the tube with the tube inserted through the opening in the center of the lid. The lid may then be placed in position on the top of the container, and the lid may be used as a surface to hold drinks and other items, and as a work surface for cutting bait, baiting and working on tackle, or other uses. One or more extensions may be connected to the top of the tube, depending upon the number of fishing poles that the user desires to have secured by the device. Once the extensions are in place, the umbrella pole may be inserted into the extensions and tube with the bottom of the umbrella pole now resting within the tube and on the bottom of the weighted container. Fishing poles, with or without fishing rod holders, may be inserted into the arms of the extensions for use.

It is therefore an object of the present invention to provide an outdoor recreational device that provides a stable base for a beach or other umbrella.

It is a further object of the present invention to provide an umbrella stand that also serves as a carrying container.

It is a further object of the present invention to provide an umbrella stand that may be weighted using readily available material such as sand, soil, rocks or other solid materials, or water in order to stabilize the umbrella for outdoor use.

It is a further object of the present invention to provide an umbrella stand that may also be utilized as a means for holding fishing rods while the fishing rods are in use.

### BRIEF DESCRIPTION OF THE DRAWINGS

These and other embodiments are described by the following figures and detailed description.

FIG. 1 is a view of an embodiment of the present invention showing a container and lid with a tube inserted through an opening in the lid and the bottom of the tube contained within a retaining portion in the bottom of a container.

FIG. 2 is a view of the present invention showing a top-down view of the base of a container with a retaining portion and a tube contained within a retaining portion in accordance with an embodiment of the present invention.

FIG. 3 is a view of an embodiment of the present invention showing a tube connected to extensions and the tube contained within a container.

FIGS. 4A-4C are views of an embodiment of the present invention showing a tube and extensions disassembled.

FIG. 5 is a view of an embodiment of the present invention showing the device assembled for use.

### DETAILED DESCRIPTION OF THE INVENTION

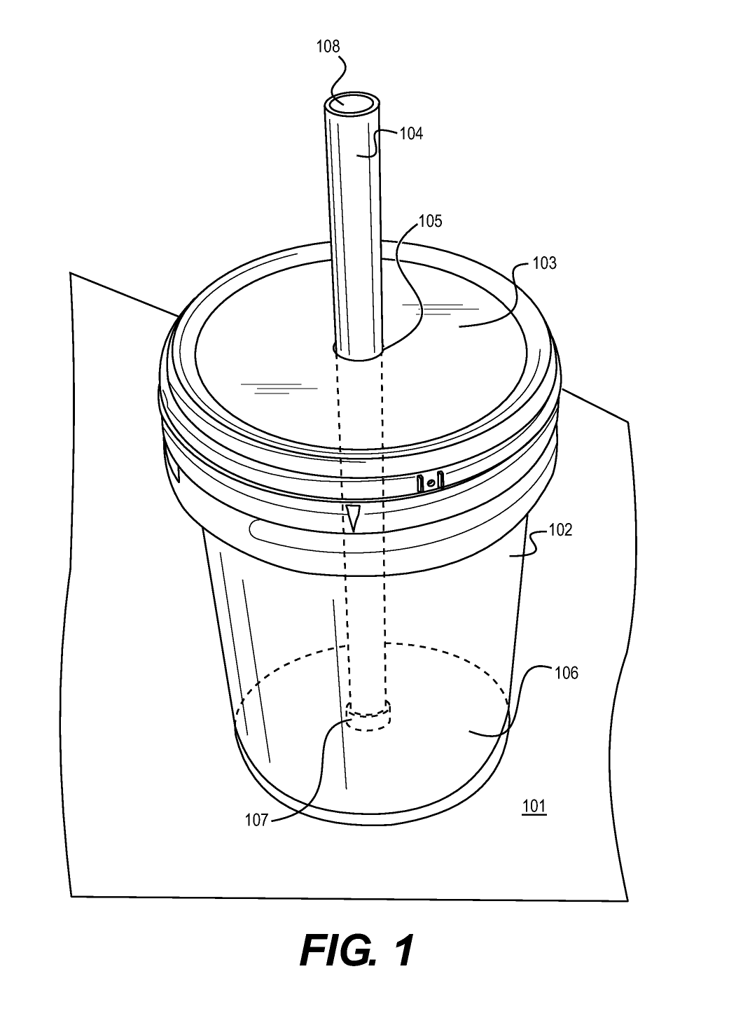

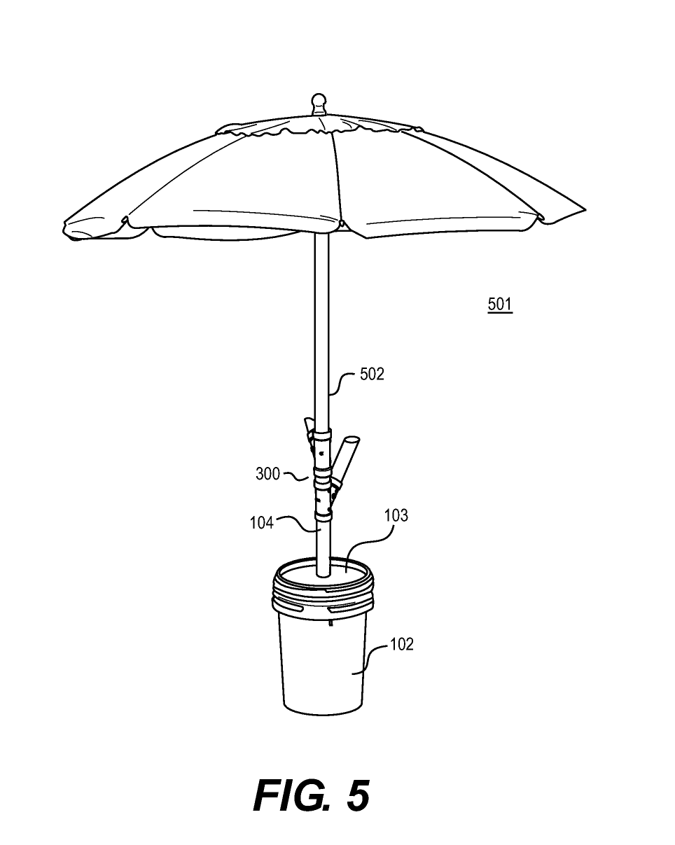

Referring now to FIG. 1, an embodiment of the present invention 101 is shown. The container 102 is shown with a lid 103 in place on the top of the container 102. A tube 104 is inserted through a hole 105 in the lid 103. The tube 104 extends downward to the base 106 of the container 102, and is inserted into a raised retaining ring 107, which has an interior diameter such that the tube 104 fits snugly within the raised retaining ring 107. The tube 104 is hollow, with an opening 108 in the upper portion of the tube 104 such that an umbrella pole (FIG. 5) may be disposed with the tube 104.

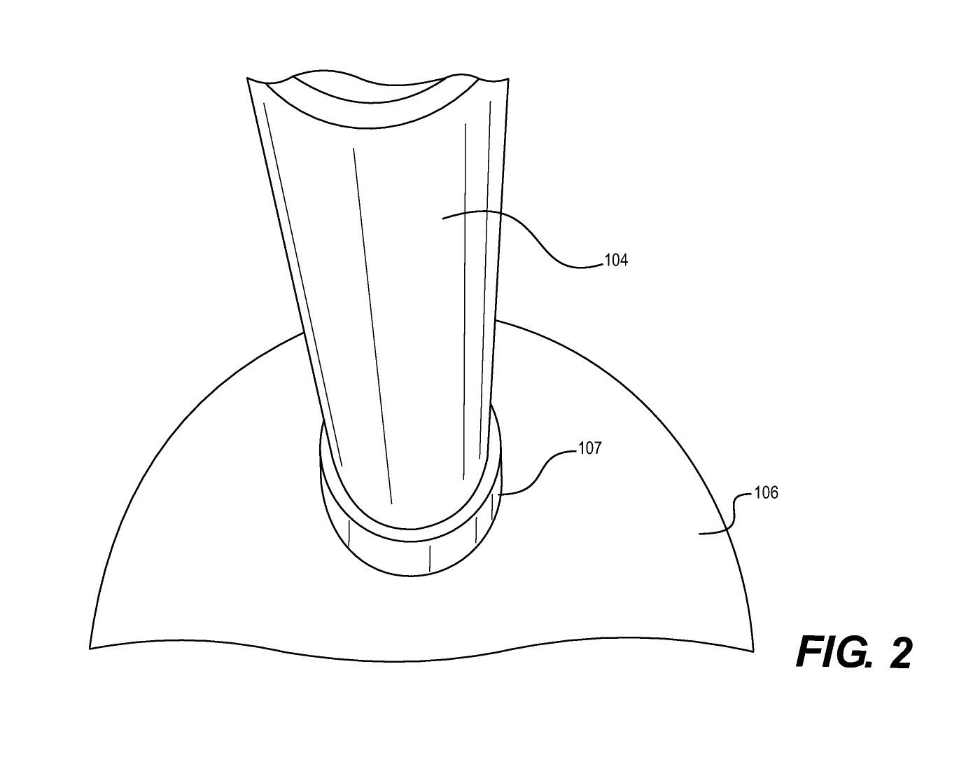

FIG. 2 shows a cutaway detail view of the base 106 with the tube 104 inserted into the raised retaining ring 107.

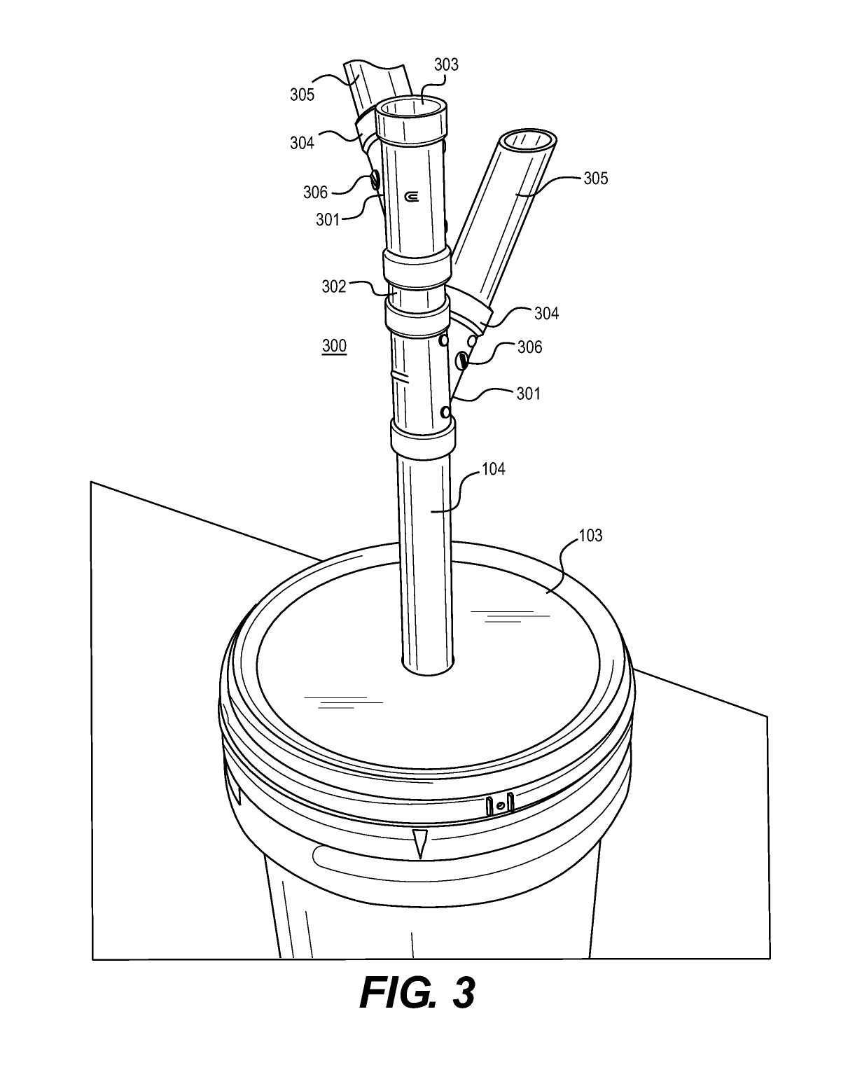

FIG. 3 shows the tube 104 in place through the lid 103 and an extension assembly 300. Affixed to the top of the tube 104 is a pair of y-extensions 301, connected with a coupling 302. The y-extensions 301 be used singly or, as shown, in a pair. It will be understood that additional y-extensions and couplings may be used with the invention without deviating from the scope and intent of the invention. The y-extensions 301 and coupling 302 are hollow, with preferentially the same inside diameter as the tube 104. The y-extensions 301 have arms 304 extending away from the vertical of the y-extensions 301, the coupling 302, and the tube 104. Use has shown that a 45 degree angle between the arms 304 and the vertical axis of the invention is advantageous for using the invention with fishing rods, but it will also be understood that other angles may be utilized without deviating from the scope and intent of the invention. The arms 304 have inserted into them fishing rod holders 305. Set screws 306 in the arms 304 may be tightened so as to ensure that the fishing rod holders 305 remain in place while the invention is in use and fishing rods (not shown) placed within the fishing rod holders 305.

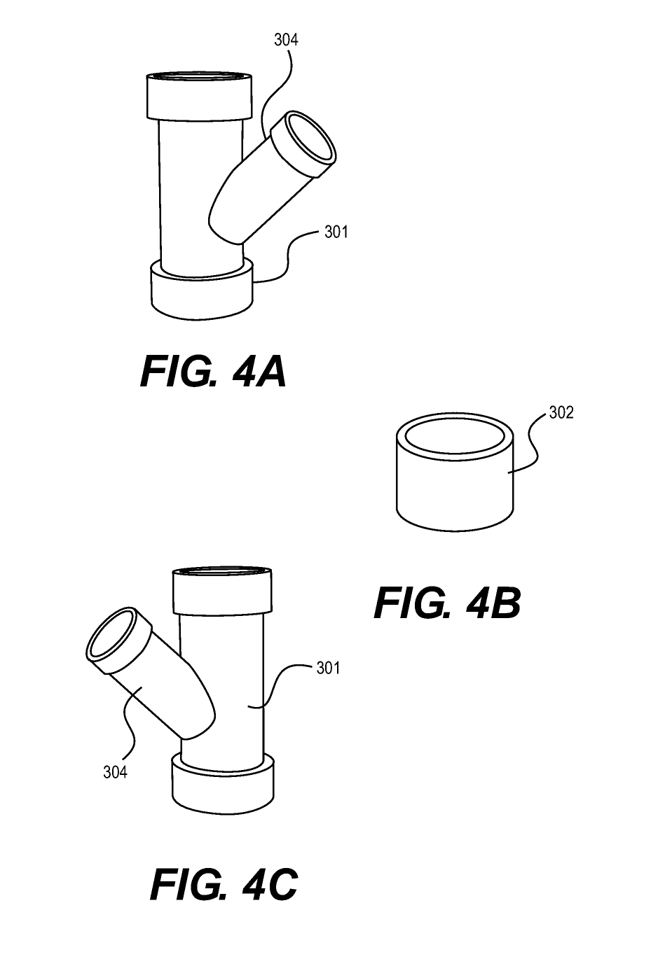

FIGS. 4A, 4B, and 4C show respectively the y-extension 301, coupling 302, and y-extension 301 as disassembled for carrying, the y-extensions 301 having arms 304.

FIG. 5 shows the invention in use, with the container 102 and lid 103 assembled, the tube 104 in place within the container 102 and lid 103, and the extension assembly 300. An umbrella 501 is disposed within the invention by having the umbrella pole 502 inserted into the extension assembly 300 and the tube 104. Preferentially, the umbrella pole 502 will be inserted fully into the invention such that the bottom of the umbrella pole 502 will rest within the tube 104 at the bottom end where the tube 104 is disposed within the raised retaining ring 107. Although not shown, it will be understood that the container 102 may contain weighting material such as sand, water, rocks or the like.

These embodiments have been described in sufficient detail to enable those skilled in the art to practice them, and it is to be understood that changes may be made without deviating from the scope of the invention described herein.

1. An umbrella stand comprising:
A container, the container having an interior, a base and an opening;
A lid that may be affixed to the opening of the container, the lid having a hole disposed in the center of the lid;
The base of the container having a raised ring disposed in the center of the base within the interior of the container;
A hollow tube having a top and bottom end, the tube being inserted vertically through the hole in the center of the lid into the interior of the container, the bottom end of the tube being inserted into the raised ring disposed in the center of the base, and the top end of the tube extending above the lid; and
At least one y-extensions, the at least one y-extension affixed to the top end of the tube above the lid, the at least one y-extensions being hollow, and the at least one y-extension having a hollow arm.

2. The umbrella stand of claim 1 wherein the at least one y-extension is two or more y-extensions, the umbrella stand further comprising one or more connectors, a first of the two or more y-extensions being connected to the top end of the tube, one of the one or more connectors being connected to the top of the first of the two or more y-extensions, and a second of the two or more y-extensions being connected to the top end of the connector connected to the first of the two or more y-extensions.

3. The umbrella stand of claim 2 wherein more connectors and y-extensions are connected in the described sequence until a desired number of y-extensions is attached to the top end of the tube.

4. The umbrella stand of claim 1 wherein the tube and one or more y-extensions may be disassembled.

5. The umbrella stand of claim 2 wherein the tube, the two or more y-extensions, and the one or more connectors may be disassembled.

6. The umbrella stand of claim 1 wherein the arm of each of the one or more y-extensions further comprises a set screw.

7. A method of using an umbrella stand, comprising the steps of assembling a container having an opening and a base with a raised ring disposed on the interior surface of the base, a lid with a hole disposed in the center, and a hollow tube, inserting the hollow tube into the raised ring, filling the container with weighting material, placing the lid over the tube such that the tube extends up through the hole in the lid and the lid is fitted to the top of the container, and attaching a first y-extension to the top end of the tube, the first y-extension having an arm.

8. The method of claim 7 wherein a connector is connected to the top of the first y-extension and a second y-extension is attached to the top of the connector, the second y-extension having an arm.

9. The method of claim 8 wherein additional connectors and y-extensions are added until a desired number of y-extensions is added to the top of the tube, the additional y-extensions each having an arm.

10. The method of claim 7 wherein an umbrella pole is inserted into the top of the assembly of the tube and y-extension.

11. The method of claim 9 wherein an umbrella pole is inserted into the top of the assembly of additional connectors and y-extensions and into the tube.

12. The method of claim 7 wherein a fishing pole is inserted into the arm of the first y-extension.

13. The method of claim 9 wherein one or more fishing poles is inserted into the arms of each of the additional y-extensions.
